(19) United States
(12) Patent Application Publication
(10) Pub. No.: US 2012/0330663 A1
(43) Pub. Date: Dec. 27, 2012

(54) IDENTITY AUTHENTICATION SYSTEM AND METHOD

(75) Inventors: YING-CHUAN YU, Tu-Cheng (TW); YING-XIONG HUANG, Tu-Cheng (TW); HSING-CHU WU, Tu-Cheng (TW); SHIH-PIN WU, Tu-Cheng (TW)

(73) Assignee: HON HAI PRECISION INDUSTRY CO., LTD., Tu-Cheng (TW)

(21) Appl. No.: 13/207,461

(22) Filed: Aug. 11, 2011

(30) Foreign Application Priority Data
Jun. 27, 2011 (TW) 100122380

(51) Int. Cl. G10L 17/00

(52) U.S. Cl. 704/246; 704/E17.001

(57) ABSTRACT

An identity authentication method is applied on a system. The system is connected to an external storage device storing a first voice model. The system includes an information server and a terminal. The information server includes a database. The information server executes the following steps. First, receiving the first voice model transmitted by the terminal. Second, determining whether the first voice model matches one second voice model, and transmitting the verification result to the terminal. The terminal executes the following steps. First, generating a prompt to prompt the user to input voice signals. Second, receiving the input voice signals. Third, extracting voice features from the input voice signals. Fourth, determining whether the extracted voice features matches the first voice model. Fifth, determining the verification result is successful when matches, and determining the identity authentication is success only when two verification results are both successful. A related system is also provided.

### BACKGROUND

1. Technical Field

The present disclosure relates to identity authentication systems and methods and, particularly, to an identity authentication system which executes double identity authentication and a method thereof.

2. Description of Related Art

Speech recognition systems are widely used in identity authentication. In such a identity authentication system, it generally determines whether features extracted from input voice signals matches voice models stored in the system. However, others may easily intercept voice signals of authorized users, which may result in unauthorized use of the voice signals, and thus the identity authentication system may be fooled by illegitimate use of the voice signals. Furthermore, in the identity authentication system, a user terminal generally serves as an input unit to receive the voice of the user, and the authenticating work is all done by an information server, which may get overloaded. Therefore, it is desirable to have a new identity authentication system and method to overcome the above shortcomings.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an identity authentication system in accordance with an exemplary embodiment.

FIG. 2 is a block diagram of a second processor of the identity authentication system of FIG. 1, in accordance with an exemplary embodiment.

FIG. 3 is a flowchart of an identity authentication method in accordance with an exemplary embodiment.

### DETAILED DESCRIPTION

The embodiments of the present disclosure are now described in detail, with reference to the accompanying drawings.

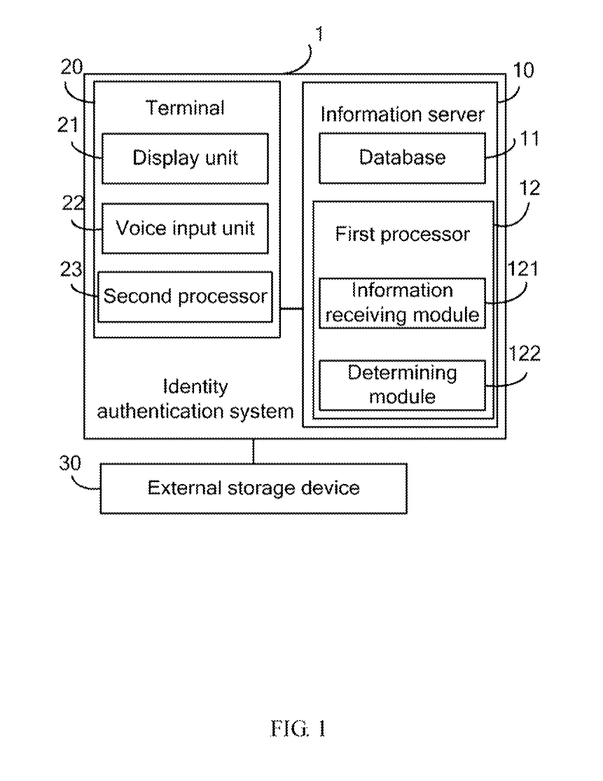

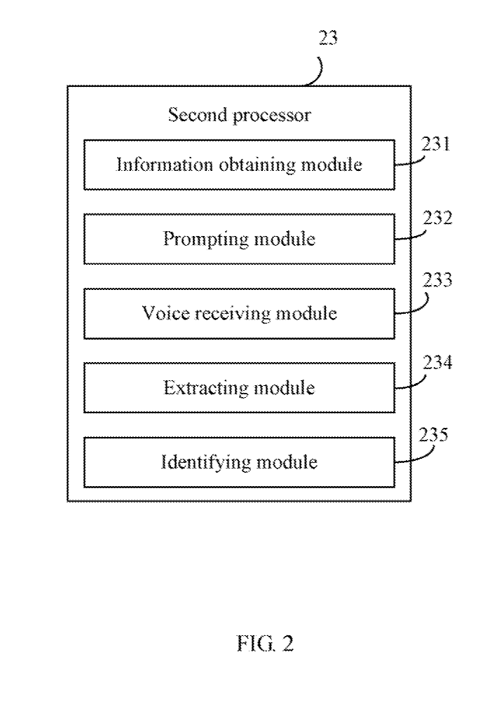

Referring to FIGS. 1-2, an identity authentication system 1 (heretofore called the system 1) in accordance with an exemplary embodiment is shown. The system 1 includes an information server 10 and at least one terminal 20. The system is connected to an external storage device 30 through the at least one terminal 20. The system 1 may be used in financial transaction. The at least one terminal 20 communicates with the information server 10 through wireless or wired networks. The terminal 20 is capable of obtaining information from the external storage device 30 and storing information to the external storage device 30. The external storage device 30 stores a first voice model. A database 11 of the information server 10 stores a number of second voice models. The first voice model may match one of the second voice models. In this embodiment, when a user first legally registers in the information server 10, the information server 10 records voice signals of the user as a second voice model, and stores the second voice model of the authorized user to the external storage device 30 through the terminal 20, and further stores the second voice model to the database 11. In the embodiment, the external storage device 30 may be a U disk, a SD card, or a mobile phone.

The information server 10 further includes a first processor 12. The first processor 12 includes an information receiving module 121 and a determining module 122. The information receiving module 121 receives a first voice model from the terminal 20. The determining module 122 determines whether the received first voice model matches one of the at least one second voice models stored in the database 11, and transmits a verification result of the first voice model to the terminal 20. If the first voice model matches one of the at least one second voice models, the determining module 122 transmits a successful verification result of the first voice model to the terminal 20. If the first voice model does not match any one of the at least one second voice models, the determining module 122 transmits an unsuccessful verification result of the first voice model to the terminal 20.

The terminal 20 includes a voice input unit 21 and a second processor 22. The voice input unit 21 is to receive voice signals of the user. In the embodiment, the voice input unit 21 is a microphone.

The second processor 22 includes an information obtaining module 221, a prompting module 222, a voice receiving module 223, an extracting module 224, and an identifying module 225. The information obtaining module 221 obtains the first voice model from the external storage device 30 when determining that the external storage device 30 is inserted into the terminal 20. The prompting module 222 generates a prompt to prompt a user to input voice signals. In the embodiment, the terminal 20 further includes a display unit 23. The prompting module 222 displays a prompt interface on the display unit 23 to prompt a user to input voice signals. The voice receiving module 223 receives the input voice signals from the voice input unit 21. The extracting module 224 extracts voice features from the input voice signals. The identifying module 225 determines whether the extracted voice features matches the obtained first voice model, and determines if the verification result of the input voice signals is successful if the extracted voice feature matches the obtained first voice model. The identifying module 225 further determines that an identity authentication of the user is successful when the verification result of the first voice model and the verification result of the input voice are both successful.

In a first embodiment, a process of the identity authentication of the user is described as follows. First, the information obtaining module 221 transmits the obtained first voice model to the information server 10 once the information obtaining module 224 obtains the first voice model from the external storage device 30, and the determining module 122 determines whether the obtained first voice model matches one of the second voice models stored in the database 11. When the obtained first voice model matches one of the second voice models, the determining module 122 transmits the successful verification result to the terminal 20. Second, the prompting module 222 generates a prompt to prompt the user to input voice signals upon receiving a successful verification result of the first voice model from the information server 10. Third, the voice receiving module 223 receives voice signals and the extracting module 224 extracts voice features from the input voice signals. Fourth, the identifying module 225 determines that the verification result of the input voice signal is successful when the extracted voice features matches the first voice model, and further determines that the identity authentication is successful when the verification result of the input voice signals is successful.

In a second embodiment, a process of the identity authentication of the user is described as follows. First, the prompting module 222 generates a prompt to prompt the user to input voice signals once determining that the external storage device 30 is inserted into the terminal 20. Second, the voice receiving module 223 receives the voice signals and the extracting module 224 extracts the voice features from the input voice signals. Third, the identifying module 225 determines that the verification result of the input voice signal is successful when the extracted voice features matches the obtained first voice model, and transmits the obtained first voice model to the information server 10 when the verification result of the input voice signals is successful. Fourth, the information server 10 determines whether the obtained first voice model matches one of the second voice models stored in the database 11, and transmits the verification result of the first voice model to the terminal 20. Fifth, the identifying module 225 determines that the identity authentication is successful upon receiving a successful verification of the first voice model.

In a third embodiment, a process of the identity authentication steps of the user is described as follow. First, the information obtaining module 221 transmits the obtained first voice model to the information server 10 once the information obtaining module 221 obtains the first voice model. The prompting module 222 simultaneously generates a prompt to prompt the user to input a voice signal when the information obtaining module 221 determines that the external storage device 30 is inserted into the terminal 10. Second, the identifying module 225 determines that the identity authentication is successful when the verification result of the first voice model and the verification result of the input voice signals are both successful.

In this way, the identity authentication uses double authentication, namely, the identity authentication is successful not only when the verification result of the input voice signals is successful, but also when the verification result of the first voice model is successful, which prevents an illegal user from using an unregistered voice model stored in the external storage device 30 or unregistered voice signals.

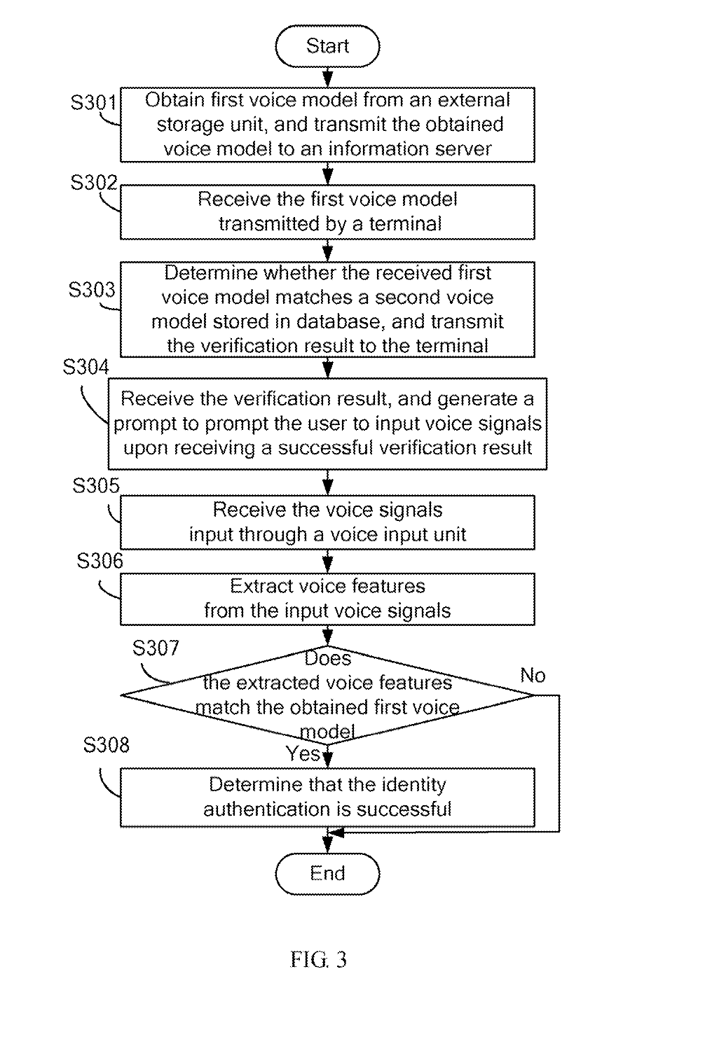

Referring to FIG. 3, a flowchart of an identity authentication method applied on the identity authentication system 1 as described in the first embodiment in accordance with an exemplary embodiment is shown.

In step S301, the information obtaining module 221 obtains a first voice model from the external storage device 30 and transmits the obtained first voice model to the information server 10 when determining that the external storage device 30 is inserted into the terminal 20.

In step S302, the information receiving module 121 receives the first voice model transmitted by the terminal 20.

In step S303, the determining module 122 determines whether the received first voice model matches one of the at least second voice model stored in the database 11 and transmits a verification result of the first voice model to the terminal 20. If there is a match, the determining module 122 transmits a successful verification result of the first voice model to the terminal. If there is no match, the determining module 122 transmits an unsuccessful verification result of the first voice model to the terminal.

In step S304, the prompting module 222 generates a prompt to prompt the user to input voice signals upon receiving a successful verification of the first voice model. When receiving an unsuccessful verification of the first voice model, the procedure stops in step S304.

In step S305, the voice receiving module 223 receives user voice signals input through the voice input unit 22.

In step S306, the extracting module 224 extracts voice features from the received user voice signals.

In step S307, the identifying module 225 determines whether the extracted voice features matches the obtained first voice model. If there is a match, the procedure goes to step S308. If there is no match, the procedure stops in step S307.

In step S308, the identifying module 225 determines that the verification result of the input voice signals is successful, and further determines that the identity authentication is successful.

The difference between the method applied on the system as described in the second embodiment and the method applied on the system as described in the first embodiment is described as follow. The information obtaining module 221 obtains first voice model from the external storage device 30 when determining that the external storage device 30 is inserted into the terminal 20. The prompting module 222 simultaneously generates a prompt to prompt the user to input voice signals. The identifying module 225 transmits the obtained first voice model to the information server 10 when determining that the verification result of the input voice signals is success. The information server 10 determines whether the obtained first voice model matches one of the second voice models stored in the database 11, and transmits the verification result of the first voice model to the terminal 20. The identifying module 225 determines that the identity authentication is successful upon receiving a successful verification of the first voice model.

The difference between the method applied on the system as described in the third embodiment and the method applied on the system as described in the first embodiment is described as follow. The prompting module 222 generates a prompt to prompt the user to input voice signals when determining that the external storage device 30 is inserted into the terminal 20. The identifying module 225 determines that the identity authentication is successful when the verification result of the input voice signals and the verification result of the first voice model are both successful.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An identity authentication system to be connected to an external storage device storing a first voice model, comprising:
a terminal comprising:
a voice input unit; and
a first processor comprising:
an information obtaining module to obtain the first voice model from the external storage device when determining that the external storage device is inserted into the terminal;
a voice receiving module to receive voice signals input through the voice input unit;
an extracting module to extract voice features from the received voice signals; and
an identifying module to determine whether the extracted voice features matches the first voice model, and determine that the verification result of the input voice signals is successful when the extracted voice features matches the first voice model; and
an information server comprising:
a database storing at least one second voice model of at least one authorized user; and
a second processor comprising:
an information receiving module to receive the first voice model from the terminal; and
a determining module to determine whether the first voice model matches one of the at least one second voice model, and transmit a verification result of the first voice model to the terminal;
wherein the identifying module further to determine that the identity authentication is successful when the verification result of the input voice signals and the verification result of the first voice model are both successful.

2. The identity authentication as described in claim 1, wherein the information obtaining module is to transmit the first voice model to the information server when determining that the external storage device is inserted into the terminal.

3. The identity authentication as described in claim 2, wherein the terminal further comprises a prompting module to generate a prompt to prompt a user to input voice signals upon receiving a successful verification of the first voice model.

4. The identity authentication as described in claim 1, wherein the terminal further comprises a prompting module to generate a prompt to prompt a user to input voice signals when the information obtaining module determines that the external storage device is inserted into the terminal.

5. The identity authentication as described in claim 4, wherein the identifying module is further to transmit the obtained first voice model to the information server when the verification result of input voice signals is successful, and determine the identity authentication is successful when the verification result of the first voice model is successful.

6. The identity authentication as described in claim 1, wherein the terminal further comprises a prompting module, the information obtaining module is to transmit the obtained first voice model to the information server, and the prompting module is to simultaneously generate a prompt to prompt the user to input voice signals when determining that the external storage device is inserted into the terminal.

7. An identity authentication method, the identity authentication method for being applied on an identity authentication system, the system being connected to an external storage device storing a first voice model, and comprising an information server and a terminal, the information server comprising a database storing at least one second voice model of the at least one authorized user, the terminal comprising a voice input unit, wherein the method comprising:
the information server executing the following steps:
receiving the first voice model transmitted by the terminal;
determining whether the received first voice model matches one of the at least one second voice model stored in the database, and transmitting a verification result of the first voice model to the terminal; and
the terminal executing the following steps:
receiving the input voice signals input through the voice input unit;
extracting voice features from the input voice signals;
determining whether the extracted voice features matches the obtained first voice model;
determining that the verification result of the input voice signals is successful when the extracted voice features matches the obtained first voice model;
determining that the identity authentication is success when the verification result of the external storage device and the verification result of the input voice are both successful.

8. The identity authentication method as described in claim 7, wherein the terminal further executes the following step:
transmitting the obtained first voice model to the information server when determining that the external storage device is inserted into the terminal.

9. The identity authentication method as described in claim 8, wherein the terminal further executes the following step:
generating a prompt to prompt the user to input voice signals upon receiving a successful verification result of the first voice model.

10. The identity authentication method as described in claim 7, wherein the terminal further executes the following step:
generating a prompt to prompt the user to input voice signals when determining that the external storage device is inserted into the terminal.

11. The identity authentication method as described in claim 10, wherein the terminal further executes the following step:
transmitting the obtained first voice model to the information server when determining that the verification result of the input voice signals is successful.

12. The identity authentication method as described in claim 7, wherein the terminal further executes the following step:
generating a prompt to prompt the user to input voice signals when determining that the external storage device is inserted into the terminal.

13. The identity authentication method as described in claim 12, further comprising:
transmitting the obtained first voice model to the information server when determining that the external storage device is inserted into the terminal.
